(19) United States
(12) Patent Application Publication
(10) Pub. No.: US 2011/0198141 A1
(43) Pub. Date: Aug. 18, 2011

(54) HYDRAULIC ELECTRIC HYBRID DRIVETRAIN

(75) Inventors: Brian M. Clark, Seattle, WA (US); Mark Case, Duvall, WA (US)

(73) Assignee: GENIE INDUSTRIES, INC., Redmond, WA (US)

(21) Appl. No.: 12/706,324

(22) Filed: Feb. 16, 2010

(51) Int. Cl. B60K 6/22; H02P 7/00; B60K 6/20

(52) U.S. Cl. 180/65.265; 318/452; 180/65.21; 180/65.275; 903/909

(57) ABSTRACT

A vehicle is provided with an engine connected to a hydraulic pump in fluid communication with a hydrostatic drive system and at least one of a plurality of traction devices connected to a hydrostatic drive motor. The vehicle also has a battery coupled to an electric machine coupled to at least one of the remaining plurality of traction devices. The electric machine acts as a motor to propel the vehicle or a generator to charge the battery. A vehicle is provided with a hydraulic drive system and an electric drive system each operably connected to a fraction device. Power may be transferable from the first drive system to the second drive system by way of ground coupling between the traction devices.

### BACKGROUND

1. Field

The following disclosure relates generally to vehicle traction and auxiliary systems. In particular, the following disclosure relates to drive systems and modes of operation for vehicles that have engine powered hydraulic systems powering traction systems and other hydraulic actuators.

2. Background Art

Vehicles such as a conventional mobile aerial work platform often include an internal combustion engine (ICE), such as a diesel engine, to provide a source of power for the vehicle. Typically, the peak horsepower of the engine must be adequate to provide sufficient power to operate the vehicle, e.g., for propulsion, deploying the aerial work platform, etc. The peak horsepower, however, is used infrequently. For example, peak horsepower of the engine is required by the machine duty cycle less than 10% of the time. Accordingly, the engine is oversized for a majority of the operations performed by the conventional vehicle. This makes the conventional vehicles heavier, larger, and more expensive to buy and to operate than is required to perform the majority of operations.

Hybrid-Electric Vehicles (HEVs), in general, employ a combination of an engine, such as a gasoline Otto-cycle engine, and an electric machine operable as one of a motor and a generator based on the desired operating state. The engine and the electric machine may be arranged in series and/or parallel configurations. A conventional series hybrid drive train propels a HEV only with the electric machine acting as a motor to drive the wheels. The electric machine (motoring) typically receives electric power from either a battery-pack or from a generator run by an engine. The battery pack provides on board energy storage and is recharged using power provided by the engine and/or electric machine (acting as a generator) as well as from energy recovered during braking, or regenerative braking. The engine in a conventional series hybrid drive train only has to meet the average driving power requirements because the battery pack supplies the additional power required for peak driving power.

A conventional parallel hybrid drive train in a HEV has both an engine and an electric machine operable as a drive motor or generator. In a parallel drivetrain, the engine is mechanically coupled to the driving wheels, such that torque from the engine, the electric machine motoring, or a combination of the two propels the vehicle. Regenerative braking is commonly used for recharging a battery pack. When driving power demands are low, the engine may turn the electric machine as a generator to recharge the battery pack, as well as provide the necessary torque to propel the vehicle.

### SUMMARY

An embodiment of the invention includes a vehicle having an engine operably connected to a hydraulic pump. The hydraulic pump is in fluid communication with a hydrostatic drive system. The vehicle has a plurality of traction devices with at least one of the traction devices operably connected to a hydrostatic drive motor of the hydrostatic drive system. The vehicle also has an electric machine operably coupled to at least one of the remaining plurality of traction devices. The electric machine is electrically coupled to a battery. The electric machine is operable as a motor to output mechanical power to said traction device, and operable as a generator to output electrical power to the battery. The traction devices support the vehicle upon a support surface.

Another embodiment of the invention includes a vehicle having an engine connected to a hydraulic pump, and the hydraulic pump is in fluid communication with a first and second hydrostatic drive motor to supply pressurized fluid thereto. The vehicle has a first pair of traction devices with each traction device operably connected to one of the hydrostatic drive motors. The vehicle also has a first and second electric machine coupled to a battery, where each electric machine is operable as a motor to output mechanical power, and operable as a generator to output electrical power to the battery. The vehicle has a second pair of traction devices, each coupled to one of the electric machines. The fraction devices support the vehicle upon the support surface.

In a further embodiment, a vehicle has a first hydraulic drive system with an engine connected to a first hydraulic pump in fluid communication with at least one hydrostatic drive motor to provide pressurized fluid thereto. The hydrostatic drive motor is connected to a first traction device. The vehicle also has a second electric drive system with at least one electric machine electrically coupled to a battery, the electric machine operable as a motor to output mechanical power, and operable as a generator to output electrical power to the battery. The electric machine is coupled to a second traction device. The first and second traction devices support the vehicle on a support surface.

### BRIEF DESCRIPTION OF THE DRAWINGS

FIG. 1 is a side view of a vehicle including a dual drive system according to one embodiment of the present invention;

FIG. 2 is a schematic top plan view of the vehicle shown in FIG. 1;

FIG. 3 is a side view of another embodiment of a vehicle including a dual drive system;

FIG. 4 is a side view of yet another embodiment of a vehicle including a dual drive system; and

FIG. 5 is a schematic of a dual drive system according to an embodiment of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

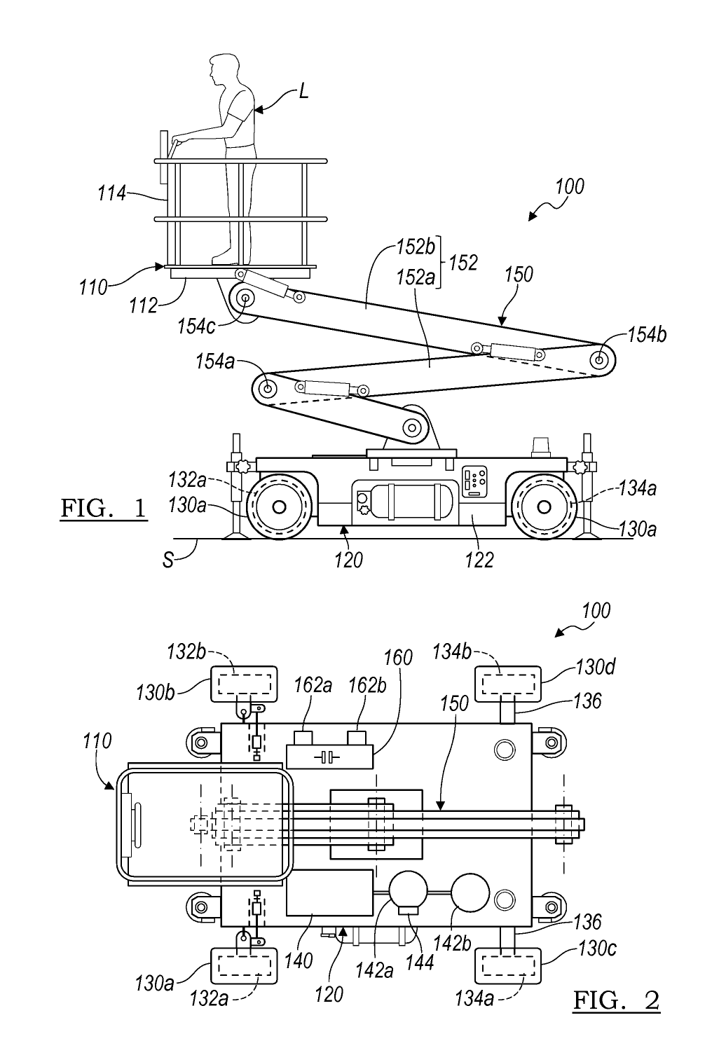

FIGS. 1-4 show various embodiments of an aerial work platform having a hydraulic electric hybrid drivetrain, otherwise known as a dual drive system. FIG. 1 is a side view of an embodiment of a vehicle 100 including a dual drive system in accordance with the present disclosure. FIG. 2 is a top plan view of the vehicle 100 shown in FIG. 1. The vehicle 100 is a utility vehicle such as an aerial work platform, a rough terrain telescopic load handler, or other vehicle suitable for lifting a load L with respect to a support surface S. The load L is, for example, one or more persons, tools, cargo, or any suitable material that may require being lifted. The support surface S is paved or unpaved ground, a road, an apron such as a sidewalk or parking lot, an interior or exterior floor of a structure, or other suitable surfaces upon which the vehicle 100 can be driven.

In FIG. 1, the vehicle 100 includes a platform 110, a chassis 120, and a support assembly 150 that couples the platform 110 and the chassis 120. The platform 110 shown in FIG. 1 includes a deck 112 with a railing 114 mounted on the deck 112. Such a platform 110 is particularly suited to carrying one or more persons and any tools or supplies that they may need. According to certain other embodiments of the present disclosure, the platform 110 may be other structures that are suitably configured to carry the load L.

The chassis 120 generally includes a frame 122, and at least three traction devices, such as wheels 130. The illustrated embodiment shows a vehicle with four wheels 130, although the vehicle may have greater or fewer wheels or other traction devices such as continuous tracks having a belt and sprockets for traversing the support surface S. The traction devices (individual wheels 130a-d are shown in FIG. 1) support the frame 122 with respect to the support surface S and are configured to move the chassis 120 with respect to the support surface S.

Each of the wheels 130 is individually driven by a respective torque source. For example, as shown in FIGS. 1 and 2, a first wheel 130a is driven by a first hydrostatic drive motor 132a, a second wheel 130b is driven by a second hydrostatic drive motor 132b, a third wheel 130c is operably coupled to a first electric machine 134a, and a fourth wheel 130d is operably coupled to a second electric machine 134b. The electric machines can operate as motors to output power or torque, or as generators to generate electricity using power or torque input. In one embodiment, the electric machines may be alternating current (AC) machines. In another embodiment, the third and fourth wheels, 130c-d, are driven by a single machine 134 connected to an axle 136, which is a live axle, dead axle, drive system having a differential, or the like (shown with phantom of electric machine 134b and electric inverter/controller 162b removed from FIG. 2). In another embodiment, the vehicle 100 has only three wheels 130, and at least one wheel 130a is driven by a hydrostatic drive motor 132 and at least one other wheel 130c is driven by an electric machine 134. The third wheel, 130b in this case, may either free-wheel, be driven by either a hydrostatic drive motor or electric machine, or be coupled to one of the other wheels via a solid axle or the like. In yet another embodiment, the vehicle 100 has a plurality of traction devices 130, including wheels or tracks. A portion of the plurality of traction devices 130 are driven by a hydrostatic drive system, which includes at least one hydrostatic drive motor 132, and the remainder of the traction devices 130 are driven by at least one electric machine 134.

The first and second wheels 130a and 130b with the hydrostatic drive motors 132 are steerable with respect to the chassis 120, and the third and fourth wheels 130c and 130d with the electric machines 134 are not steerable as shown in FIG. 2. In other embodiments, the electric machines 134a and 134b may be operably coupled to the steerable wheels and the hydrostatic drive motors 132 driving the wheels that are not steerable, or all four wheels 130 may be steerable with respect to the chassis 120.

FIGS. 1 and 2 show the hydrostatic drive motors 132 and electric machines 134 individually incorporated into the hubs of the wheels 130. However, certain other embodiments may include wheels that are not individually driven such as where the non-steerable wheels share a common drive motor. Still other embodiments may include the hydrostatic drive(s) 132 and electric machine(s) 134 supported on the chassis and rotatably coupled to the wheels by, e.g., drive shafts, universal joints, etc.

The hydrostatic drive motors 132 may include hydraulic motors, or other suitable devices that use pressurized fluid to produce torque. Moreover, the hydrostatic drive motors may include fixed or variable displacement motors. Certain other embodiments according to the present disclosure include permanent magnet direct current (DC) electric motors or other electric motors as torque sources in place of the hydrostatic drive motors 132.

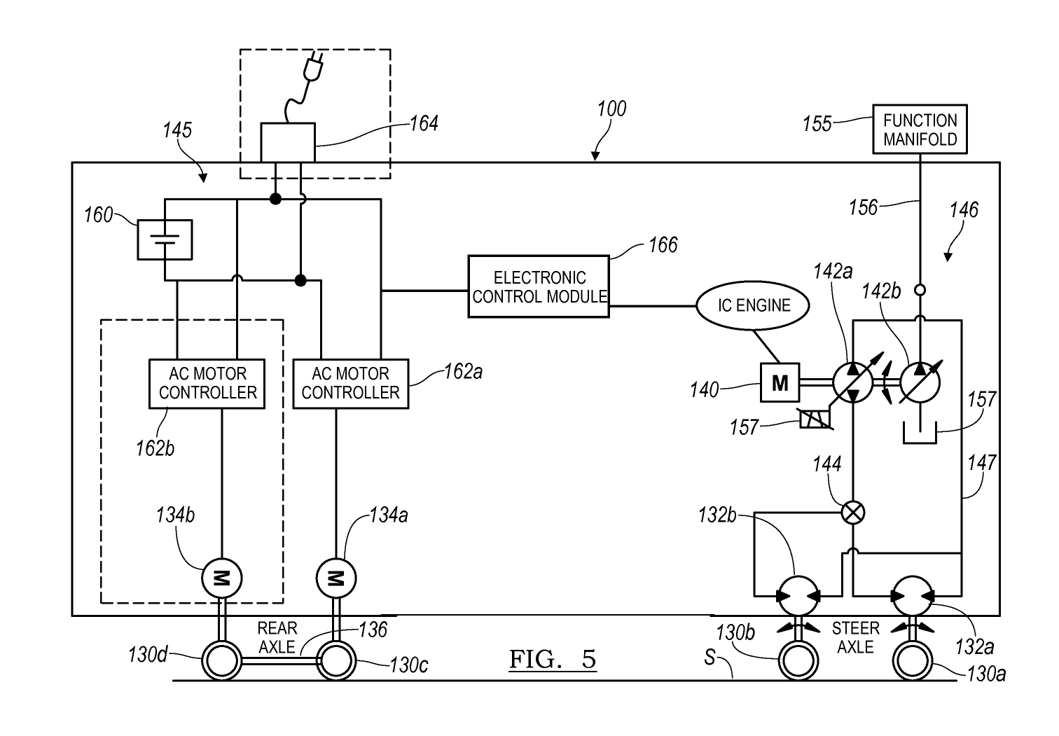

The chassis 120 supports an engine 140, a first hydraulic pump 142a, a second hydraulic pump 142b, and a valve 144. The engine 140 is an internal combustion engine (ICE), gas turbine, stirling engine, steam engine, or other power source as is known in the art. The chassis 120 also supports an electric power source 160 such as a battery, and inverter/controllers 162a and 162b. The relationships between these features for certain embodiments in accordance with the present disclosure will be described in greater detail below with respect to FIG. 5.

According to one embodiment, the engine 140 is a diesel engine having a power output of approximately one-half of the horsepower required for a conventional aerial work platform. For example, if a conventional aerial work platform requires 50+ horsepower, the engine 140 could have a power output of approximately 10-25 kilowatts (approximately 13.4-33.5 horsepower), and may be approximately 18.5 kilowatts (24.8 horsepower). The engine 140 may run at one of a plurality of constant speeds, run at varying speeds, or run at a constant speed, or power output, or torque output, such as one that would maximize fuel efficiency for example.

The hydraulic pumps 142 are variable displacement pumps, fixed displacement pumps, load sensing pumps, pressure compensated pumps, gear pumps, or other suitable devices that are driven by the engine 140 to produce pressurized fluid flows. Valving 144 is a flow diverter/combiner or another suitable valve to control the flow of pressurized fluid from the first hydraulic pump 142a to the hydrostatic drive motors 132. In one alternative, the valve 144 can be replaced by a hydraulic tee if traction control is not an issue. In another alternative, the first hydraulic pump 142a may be replaced with a pair of hydraulic pumps, each driving a respective single wheel 130 to achieve traction control objectives. The hydrostatic motors 132 may be plumbed in series or in parallel. Other valves (not shown) in the hydraulic loop 156 can be used to control the flow of pressurized fluid from the second hydraulic pump 142b for controlling movements of the support assembly 150 using a function manifold 155 (shown in FIG. 5).

The support assembly 150 couples the platform 110 and the chassis 120, and is configured to move the platform 110 between a stowed position and a deployed position with respect to the chassis 120. In the illustrated embodiment, the support assembly 150 includes a boom 152 with articulated boom segments 152a and 152b. The boom segment 152a is pivotally coupled at its ends by pins 154a and 154b with respect to the frame 122 and the boom segment 152b, respectively. The boom segment 152b is pivotally coupled at its ends by pins 154b and 154c with respect to the boom segment 152a and the platform 110, respectively. A system of hydraulic valves and hydraulic actuators (not shown), driven by the pressurized fluid in the function manifold 155, are used in a manner well understood to move the boom segments 152a and 152b with respect to the platform 110 and the frame 122 so as to move the platform 110 between the stowed and deployed positions.

The battery 160 may include a plurality of battery cells or modules arranged in series and/or parallel to supply a desired voltage and provide a desired storage capacity. For example, the battery 160 supplies voltages in a suitable voltage range for powering the electric motors 134. In short, the battery 160 includes any suitable form of electric storage and is generally rechargeable by at least one of the on-board systems described herein and an external power supply (such as a connection to load center receiving electric power from another source).

The nominal battery voltage of the battery 160 may be approximately 96 to 300 volts DC, or another typical battery voltage. Also, the capacity of the battery 160 is as much as approximately 500 amp-hours, or another suitable capacity for supplying approximately 50% of the peak driving power of the vehicle 100 and/or supplying 100% of the driving power required to operate the vehicle 100 without running the engine 140. The battery 160 may be sized to provide two to eight hours of normal duty with the engine 140 not operating. The battery 160 capacity may be decreased if the vehicle 100 is not intended for operation with the engine 140 inoperable. The batteries may be designed to accommodate indoor use of the vehicle 100 in places where exhaust emissions might otherwise present a hazard.

The inverter/controllers 162 electrically couple the electric machines 134 with the battery 160. These electrical couplings are bi-directional. Specifically, the inverter/controllers 162 can power the electric machines 134 for operation as motors with electricity supplied from the battery 160, or the inverter/controllers 162 can recharge the battery 160 with electricity generated by the electric machines 134 acting as generators.

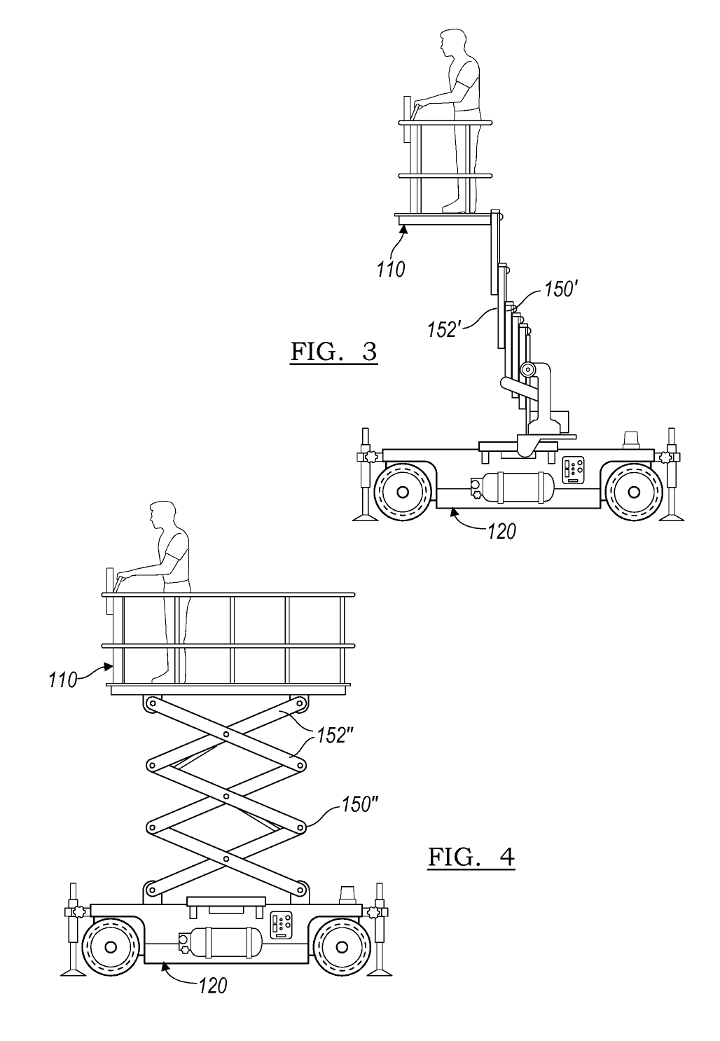

FIGS. 3 and 4 are side views of other embodiments of vehicles in accordance with the present invention. In FIG. 3, a support assembly 150′ includes an extensible mast in lieu of the articulated boom 150 of FIGS. 1 and 2. The support assembly 150′ includes a plurality of segments 152′ that are extensible with respect to one another to deploy the platform 110 (generally shown in FIG. 3), and are retractable with respect to one another to stow the platform 110. In FIG. 4, the support assembly 150″ includes a scissor apparatus in lieu of the articulated boom 150 of FIGS. 1 and 2. The support assembly 150″ includes a plurality of segments 152″ that are pinned together as a linkage that is spread to deploy the platform 110, and is folded to stow the platform 110. Otherwise, the features of FIGS. 3 and 4 that are similar to those of FIGS. 1 and 2 are indicated with similar reference numbers. In other embodiments, telescopic boom members or other linkages may additionally or alternatively be included to facilitate lifting the load. Other types of equipment that may use a hydraulic electric hybrid drivetrain system include hydrostatic front end loaders, skid steer loaders, wheeled excavators, and the like.

The components of the electric drive may be later added or retrofitted onto existing conventional vehicles in order to provide a hybrid hydrostatic drive vehicle 100. A retrofit may include the addition of a battery 160, modifying traction devices 130 to include electric machines 134 and controllers 162, as well as programming an electronic controller 166 with the operation modes, etc. required for the hybrid system. The electric drive components would be packaged into the existing conventional vehicle.

FIG. 5 shows a schematic diagram of aspects of an embodiment of a dual drive vehicle 100. The first drive system 145 of the dual drive vehicle 100 has an internal combustion engine 140, a first and second hydraulic pump 142a-b, a pair of hydrostatic drive motors 132, and a pair of wheels 130. In an alternate embodiment, only one hydrostatic drive motor 132 may be used and connected to the pair of wheels 130 using a differential or the like. The second drive system 146 of the dual drive vehicle 100 has electric machines 134, a pair of wheels 130, the battery 160, and the inverter/controllers 148.

The engine 140 rotates both hydraulic pumps 142. The first hydraulic pump 142a is connected and driven by the engine 140. The second hydraulic pump 142b is connected to the first hydraulic pump 142a through a torque coupling such as a splined connection, a piggybacked connection, or the like. In some embodiments, the second hydraulic pump 142b may also be driven directly by the engine 140. The engine 140 may be also connected to a starter system and battery (not shown), that is separate from battery 160. In another embodiment, the starter system for the engine 140 is connected to battery 160.

The first hydraulic pump 142a supplies pressurized fluid to either or both of the hydrostatic drive motors 132 via a hydrostatic drive loop 147. Valving 144 in the hydrostatic drive loop 147 directs that pressurized fluid equally or disparately to the hydrostatic drive motors 132, and can also reverse the flow of the pressurized fluid, e.g., to reverse the drive of the first and second wheels 130a and 130b. The hydrostatic loop 147 provides all of the driving power required by the vehicle 100 under most circumstances. Two examples of possible circumstances when additional driving power may be required by the vehicle 100, and the use of electric machines 134 may be necessary, include inadequate traction with the first and second wheels 130a and 130b (i.e., one or both of these wheels slip on the support surface S) and when the grade on which the vehicle 100 is operating exceeds a certain percentage (i.e. 50%, of the maximum grade on which the vehicle 100 is rated to operate).

The second hydraulic pump 142b supplies pressurized fluid to the function manifold 155 through hydraulic loop 156. The second hydraulic pump 142b and corresponding hydraulic loop 156 shares a common reservoir system 157 with the first hydraulic pump 142a and hydrostatic drive loop 147. Alternatively, the two hydraulic pumps 142 and their corresponding drive loops 147, 156 do not share a reservoir system and are separate from one another, allowing for the use of two hydraulic fluids if desired.

The inverter/controllers 162 couple the electric machines 134 to the battery 160. If the inverter/controllers 162 detect that either of the first and second wheels 130a and 130b are slipping, the inverter/controllers 162 power the electric machines 134 with the battery 160. Thus, the electric machines 134 drive the third and fourth wheels 130c and 130d to add to the driving power of the first and second wheels 130a and 130b. The inverter/controllers 162 may detect slippage by the first and second wheels 130a and 130b by comparing encoder bearing feedback from the electric machines 134 with the flow rate of the pressurized fluid supplied to the hydrostatic drive motors 132. The flow rate of the pressurized fluid is known to correlate with the control current supplied by the vehicle controller (not shown) to the coils controlling the pump 142a swash plate. Other techniques, methods, or sensors to detect slippage of the first and second wheels 130a and 130b may be used as deemed suitable.

If the inverter/controllers 162 detect the need to retard movement of the vehicle 100 on the support surface S, e.g., when operating the vehicle 100 on a downward slope, the inverter/controllers 162 can also operate either or both of the electric machines 134 as generators for regenerative braking During regenerative braking, third and fourth wheels 130c and 130d back-drive the electric machines 134, which generates an electrical current in the electric machine(s) 134 acting as generator(s). The inverter/controller(s) 162 use that electrical current to recharge the battery 160 as needed.

A separate charging system 164 (shown in phantom on FIG. 5) may be used with the vehicle 100 in order to recharge the battery 160 from an external power source such as a 120/240 Volt wall socket or other power source. For instance, if the battery 160 is in a low state of charge, the charging system 164 may be used to charge the battery 160. The charging system 164 may be external to the vehicle 100 or located onboard.

The vehicle 100 has several operating modes. An electronic control system or module 166 may be used to determine the desired operating mode, initiate an operating mode or switch between operating modes. The electronic control system 166 can provide for user interface, maintenance interface, system control, etc. In the first operating mode, the engine 140 rotates the first hydraulic pump 142a such that the first hydraulic pump 142a supplies pressurized fluid to the hydrostatic drive motors 132, which drive the first and second wheels 130a and 130b on the support surface S to propel the chassis 120. The third and fourth wheels 130c and 130d roll and interact with the support surface S and back drive the first and second machines 134a and 134b as generators. The first and second machines 134 acting as generators recharge the battery 160 via the inverter/controllers 162.

The third and fourth wheels 130c and 130d of the second drive system 147 are rotatably coupled via the support surface S to the first and second wheels 130a and 130b of the first drive system 145. Thus, the power for recharging the battery 160 is provided primarily through a “ground coupling” via the support surface S. In the present disclosure, the phrase “ground coupling” generally refers to the third and fourth wheels 130c and 130d rolling on the support surface S so as to back drive the first and second machines 134a and 134b acting as generators, which recharge the battery 160.

In the first operating mode, the vehicle 100 energy primarily provides the energy that is converted to recharge the battery 160. The vehicle 100 gains energy by traveling on a downward sloping support surface S and/or through use of the engine 140. When the downward slope or grade of the support surface S is such that the gravity increases the vehicle 100 energy, then regenerative braking can be applied through the electric machines 134 to recharge the battery 160.

In a second operating mode, the engine 140 rotates the first hydraulic pump 142a such that the first hydraulic pump 142a supplies pressurized fluid to the first and second hydrostatic drive motors 132a and 132b, thereby driving the first and second wheels 130a and 130b on the support surface S to propel the vehicle 100. The battery 160 powers the electric machines 134 as motors to drive the third and fourth wheels 130c and 130d on the support surface S to additionally propel the chassis 120.

In the second operating mode, the third and fourth wheels 130c and 130d add driving power to that of the first and second wheels 130a and 130b. The second operating mode may be invoked when either or both of the first and second wheels 130a and 130b lose traction, i.e., begin to slip, and/or when the vehicle 100 decelerates during the first operating mode. The latter circumstance may occur, for example, when the vehicle 100 encounters an upward sloping grade of the support surface S such that gravity tends to decelerate the vehicle 100.

The engine 140 is often operated at an approximately steady output to increase engine efficiency. When there is excess power output by the engine 140 that is not required to propel the vehicle 100, the excess power may be transferred from the hydrostatic drive system through ground coupling to the electric drive system to back-drive the electric machines 134 as generators and charge the battery 160. When there is insufficient power from the engine 140 to propel the vehicle 100 as desired, additional power may be provided by the electric machines 134 as motors. This ability to augment power to the vehicle 100 with the electric machines 134 acting as motors allows for a smaller engine 140 than is typical with a conventional aerial work platform. The changes in required power by the vehicle 100 may be managed by the electric machines 134 acting as motors or generators, while the engine 140 runs at a generally stabilized power output within a desired range. The vehicle 100 may operate in a 2 wheel drive (2WD) configuration when only the engine 140 is powering the vehicle 100, in a 2WD configuration when only the electric machines 134 a,b are powering the vehicle 100, and operate as needed in a four wheel drive (4WD) or all wheel drive (AWD) configuration.

A third operating mode for the vehicle 100 operates in an electric only mode, with the engine 140 inoperative. The first and second electric machines 134a-b act as motors to use power from the battery 160 to drive wheels 130c-d on the support surface S to propel the vehicle 100. The third operating mode, with the engine 140 inoperative, allows for the vehicle 100 to be operated emissions free for a period of time. The time of operation for the third operating mode is generally related to the capacity of the battery 160. The battery 160 can be recharged after electric only use of the vehicle 100, either through the vehicle 100 operating in the first operating mode or by charging the battery 160 using the external charging system 164 if the vehicle 100 is equipped with one.

The engine 140 does not emit combustion products in the third operating mode, which may be advantageous when operating the vehicle 100 in circumstances where the emissions from the engine 140 are not desirable. Examples include operating the vehicle 100 inside a building and/or in proximity to an event where noise pollution is undesirable. The third operating mode may also be advantageous in circumstance when it is less desirable to start the engine 140, such as when the vehicle 100 only needs to be moved a short distance.

In the fourth operating mode, the engine 140 rotates the first hydraulic pump 142a such that the first hydraulic pump 142a supplies pressurized fluid to the hydrostatic drive motors 132, which drive the first and second wheels 130a and 130b on the support surface S to propel the chassis 120. The third and fourth wheels 130c and 130d roll and interact with the support surface S and the first and second electric machines 134a, 134b freewheel. The vehicle 100 is driven using power from the engine 140.

A fifth operating mode for the vehicle 100 allows for use of the function manifold 155, a system of valves and actuators, for an operation such as lifting a load L on the platform 110. The engine 140 operates to drive the second hydraulic pump 142b and provide pressurized fluid to the function manifold 155. The engine 140 may drive the first hydraulic pump 142a to supply pressurized fluid to the hydrostatic drive motors 132, which drive the first and second wheels 130a and 130b on the support surface S to propel the chassis 120. Alternatively, the vehicle 100 may be stationary during use of the function manifold 155, or be propelled by way of the electric machines 134.

According to other embodiments, the engine 140 may have an alternator (not shown) to supplementally charge the battery 160, and the alternator may include a converter to boost the voltage output of the alternator to a voltage greater than the battery 160 voltage. The first drive system 145 with the engine 140 may also have a transmission (not shown) such as a planetary gearset or other torque transfer or torque splitting device to provide power to the hydraulic pumps 142 a-b.

Hydrostatic braking is replaced by regenerative braking under many circumstances; however, in some embodiments, hydrostatic braking remains available. Using regenerative braking recovers energy and may reduce wear on the components of the hydrostatic drive loop 147. If one drive system fails, the other system is independently able to propel the vehicle.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed is:

1. A vehicle comprising:
an engine operably connected to a hydraulic pump, the hydraulic pump in fluid communication with a hydrostatic drive system;
a plurality of traction devices, wherein at least one of the devices is operably connected to a hydrostatic drive motor of the hydrostatic drive system; and
an electric machine operably coupled to at least one of the remaining plurality of traction devices, the electric machine electrically coupled to a battery, the electric machine operable as a motor to output mechanical power to said traction device, and operable as a generator to output electrical power to the battery;
wherein the fraction devices support the vehicle upon a support surface.

2. The vehicle of claim 1 further comprising a system of hydraulic valves and actuators in fluid communication with the hydraulic pump to receive pressurized fluid therefrom and perform a function.

3. The vehicle of claim 1 further comprising a second hydrostatic drive motor operably connected to another one of the remaining plurality of traction devices, wherein the second hydrostatic drive motor is in fluid communication with the hydraulic pump to receive pressurized fluid therefrom.

4. The vehicle of claim 3 further comprising a second electric machine operably coupled another one of the remaining plurality of traction devices, the second electric machine electrically coupled to the battery, the electric machine operable as a motor to output mechanical power to said traction device, and operable as a generator to output electrical power to the battery.

5. The vehicle of claim 1 wherein the engine is operated within a desired output range by using the electric machines as one of motors and generators to stabilize the engine output.

6. The vehicle of claim 1, further comprising a charger configured to output power from an external electric power supply to the battery.

7. The vehicle of claim 1 further comprising a second hydraulic pump operatively coupled to the engine, the second hydraulic pump in fluid communication with a system of hydraulic valves and actuators to supply pressurized fluid thereto.

8. The vehicle of claim 1 operable in a first operating mode, wherein the engine is configured to power the hydraulic pump, thereby supplying pressurized fluid to the hydrostatic drive motor and driving the traction device connected to the hydrostatic drive motor to propel the vehicle across the support surface, and wherein the traction device coupled to the electric machine interacts with the support surface to power the electric machine as a generator to output electrical power to the battery.

9. The vehicle of claim 1 operable in a second operating mode, wherein the engine is configured to power the hydraulic pump, thereby supplying pressurized fluid to the hydrostatic drive motor and driving the traction device connected to the hydrostatic drive motor to propel the vehicle across the support surface, and wherein the battery is configured to power the electric machine as a motor to drive the traction device coupled to the first electric machine and additionally propel the vehicle across the support surface.

10. The vehicle of claim 1 operable in a third operating mode to propel the vehicle, wherein the electric machine is configured to act as a motor and uses battery power to drive the traction device coupled to the electric machine to propel the vehicle across the support surface; and
wherein the vehicle is configured to operate using electricity with the engine inoperative.

11. The vehicle of claim 1 operable in a fourth operating mode wherein the engine is configured to power the hydraulic pump, thereby supplying pressurized fluid to the hydrostatic drive motor and driving the traction device connected to the hydrostatic drive motor to propel the vehicle across the support surface, and
wherein the electric machine is configured to freewheel.

12. The vehicle of claim 7 further comprising a fifth operating mode wherein the engine is configured to power the second hydraulic pump, thereby supplying pressurized fluid to the system of hydraulic valves and actuators to perform an function.

13. The vehicle of claim 1 further comprising a second battery operably connected to an engine starting circuit.

14. A vehicle comprising:
an engine connected to a hydraulic pump, the hydraulic pump in fluid communication with a first and second hydrostatic drive motor to supply pressurized fluid thereto;
a first pair of traction devices, each traction device operably connected to one of the hydrostatic drive motors;
a first and second electric machine electrically coupled to a battery, each electric machine operable as a motor to output mechanical power, and operable as a generator to output electrical power to the battery;
a second pair of traction devices, each traction device operably connected to one of the electric machines;
wherein the traction devices support the vehicle upon the support surface.

15. The vehicle of claim 14 wherein the first and second electric machines were configured on the vehicle during a retrofitting process on an existing hydraulic vehicle.

16. A vehicle comprising:
a hydraulic drive system having an engine connected to a hydraulic pump in fluid communication with at least one hydrostatic drive motor to provide pressurized fluid thereto, the hydrostatic drive motor operable coupled to a first traction device; and
an electric drive system having at least one electric machine electrically coupled to a battery, the electric machine operable as a motor to output mechanical power, and operable as a generator to output electrical power to the battery, the electric machine operably coupled to a second traction device;
wherein the first and second traction devices support the vehicle on a support surface.

17. The vehicle of claim 16 wherein power is transferable from the hydraulic drive system to the electric drive system by way of a ground coupling between the first and second traction devices.

18. The vehicle of claim 17 further comprising a system of hydraulic valves and actuators in fluid communication with the first hydraulic drive system.

19. The vehicle of claim 17 operable in a first operating mode, wherein the first hydraulic drive system is configured to propel the vehicle across the support surface, and wherein the second electric drive system is configured to output electrical power to the battery.

20. The vehicle of claim 17 operable in a second operating mode, wherein the first hydraulic drive system is configured to propel the vehicle across the support surface, and wherein the second electric drive system is configured to additionally propel the vehicle across the support surface.
